(19) United States
(12) Patent Application Publication
(10) Pub. No.: US 2022/0077626 A1
(43) Pub. Date: Mar. 10, 2022

(54) CONNECTOR HOUSING AND WIRE HARNESS

(71) Applicant: Yazaki Corporation, Tokyo (JP)

(72) Inventors: Takahiko Sato, Kakegawa-shi (JP); Shin Kono, Kakegawa-shi (JP)

(73) Assignee: Yazaki Corporation, Tokyo (JP)

(21) Appl. No.: 17/464,923

(22) Filed: Sep. 2, 2021

(30) Foreign Application Priority Data
Sep. 8, 2020 (JP) 2020-150594

(51) Int. Cl. H01R 13/52

(52) U.S. Cl. CPC H01R 13/5205; H01R 2201/26

(57) ABSTRACT

A connector housing includes a housing main body, a seal element configured to tightly seal a gap between an outer circumferential surface of an electric wire section of a terminal-equipped electric wire and an inner circumferential surface of the housing main body, and a rear holder which is a lid element configured to be attached to the housing main body so as to close the rear side opening and has a passage hole and a protrusion, the passage hole allowing the electric wire section to pass therethrough and having a larger opening area than a radial cross section area of the electric wire section, wherein the protrusion protrudes from a portion of an inner circumferential surface of the passage hole in a circumferential direction with a protrusion length, the protrusion length being adapted to an inner circumference position of a sealing through hole.

### BACKGROUND OF THE INVENTION

### Technical Field

The present invention relates to a connector housing configured to accommodate a connector terminal of a terminal-equipped electric wire, and a wire harness with such a connector housing.

### Background Art

For example, a wire harness may be intended to be arranged at a location which may be subject to liquid splashing such as water, such as wiring under a bottom of an automobile. Conventionally, many of wire harnesses to be arranged at such a location have a structure for suppressing liquid entering the inside of a connector housing, the connector housing being provided at an end of the wire harness. In such a connector housing, an electric wire section of a terminal-equipped electric wire with a connector terminal accommodated therein may extend to the outside at a rear side of the connector housing, wherein this rear side tends to be weakened with regard to liquid entering the inside. Here, the connector housing often has a structure on the rear side on which the electric wire section extends out, the structure being configured for suppressing liquid entering the rear side.

As an example for such a structure, a structure is known which tightly seals a gap between an outer circumferential surface of the electric wire section and an inner circumferential surface of a tubular housing main body of the connector housing with a seal element in a rear side opening of the housing main body, the seal element containing a resin (e.g. see Patent Document 1). In this structure, the seal element is fitted into the rear side opening of the housing main body, and the rear side opening is closed by means of a rear holder in order to prevent this seal element from dropping out. Further, the seal element comes into tight contact with an inner circumferential surface of the housing main body, and has a sealing through hole which comes into tight contact with the outer circumferential surface of the electric wire section on an inner circumferential side, wherein the rear holder has a passage hole which allows the electric wire section to pass therethrough to the outside.

In this case, in view of the operability for assembling the wire harness, it is desirable that a resistance force is reduced which is present when passing the electric wire section of the terminal-equipped electric wire through the sealing through hole of the seal element and/or through the passage hole of the rear holder. With regard to the sealing through hole, a certain resistance is unavoidable since it is required to be in tight contact with the outer circumferential surface of the electric wire section. On the other hand, with regard to the passage hole of the rear holder, a larger opening area of the passage hole than a radial cross section area of the electric wire section results in reduction of the resistance force, which enables the operability for assembling the wire harness to be improved to a corresponding extent.

### CITATION LIST

### Patent Literature

Patent Document 1: JP 2019-200907 A

### SUMMARY OF THE INVENTION

Here, depending on an arrangement geometry of the wire harness, the electric wire section extending out of the passage hole of the rear holder may be bent in a direction which follows the arrangement geometry. In the case of a larger passage hole of the rear holder as described above, the electric wire section is tilted in the bending direction due to a clearance between the inner circumferential surface of the passage hole and the outer circumferential surface of the electric wire section. As a result, the electric wire section may be drawn to one side also in the sealing through hole due to tilting the electric wire section within the passage hole, wherein an inner circumference of the sealing through hole is compressed on this one side to increase the tight contact while a tight contact on the opposite side may be reduced. Such an inhomogeneous tight contact for the sealing through hole may result in reduction of a sealing performance of the seal element which is not desirable.

Therefore, the present invention is focused on problems as above described, and an objective of the present invention is to provide a connector housing which can simultaneously achieve an improved operability for assembling a wire harness as well as a suppressed reduction of a sealing performance in the case of bending an electric wire section of a terminal-equipped electric wire. Another objective of the present invention is to provide a wire harness with such a connector housing.

In order to achieve the above-described objective, a first connector housing includes a housing main body having a tubular shape and configured to accommodate a connector terminal of a terminal-equipped electric wire in order to connect the connector terminal to a partner connector terminal in a connected side opening of the housing main body for a partner connector; a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and a rear holder which is a lid element configured to be attached to the housing main body so as to close the rear side opening and has a passage hole and a protrusion, the passage hole allowing the electric wire section to pass therethrough and having a larger opening area than a radial cross section area of the electric wire section, wherein the protrusion protrudes from a portion of an inner circumferential surface of the passage hole in a circumferential direction with a protrusion length, the protrusion length being adapted to an inner circumference position of the sealing through hole.

Furthermore, in order to achieve the above-described objective, a second connector housing includes a housing main body having a tubular shape and configured to accommodate a connector terminal of a terminal-equipped electric wire in order to connect the connector terminal to a partner connector terminal in a connected side opening of the housing main body for a partner connector; a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and a rear holder which is a lid element configured to be attached to the housing main body so as to close the rear side opening and has a passage hole allowing the electric wire section to pass therethrough and having a larger opening area than a radial cross section area of the electric wire section, wherein the passage hole is disposed in such a way that a portion of an inner circumferential surface of the passage hole in a circumferential direction is positioned in a position adapted to an inner circumference position of the sealing through hole.

Further, in order to achieve the above-described objective, a wire harness includes a terminal-equipped electric wire; and the first connector housing or the second connector housing as described above which accommodates the connector terminal of the terminal-equipped electric wire.

In the first connector housing as described above, the passage hole of the rear holder for passing the electric wire section of the terminal-equipped electric wire therethrough has a larger opening area than the radial cross section area of the electric wire section, whereby the resistance force is reduced which is present when passing the electric wire section through this passage hole. With this reduction of the resistance force, it is possible to improve the operability for assembling a wire harness having this first connector housing. Furthermore, the protrusion is provided in the portion of the inner circumferential surface of the passage hole in the rear holder, the protrusion protruding therefrom with the protrusion length which is adapted to the inner circumference position of the sealing through hole. If the electric wire section is bent toward the portion with the protrusion provided therein, this results in suppression of tilting the electric wire section in the passage hole of the rear holder by the protrusion. With this suppression of tilting in the rear holder, it is also possible to suppress the electric wire section tilting in the sealing through hole of the seal element which may cause an inhomogeneous contact with the electric wire section. Accordingly, reduction in the sealing performance of the seal element can be suppressed by operation in a design phase which provides the above-mentioned protrusion at the portion of the inner circumferential surface of the passage hole of the rear holder, the portion corresponding to a bending direction of the electric wire section of the terminal-equipped electric wire. In this manner, the first connector housing enables the operability for assembling the wire harness to be improved while simultaneously suppressing the reduction of the sealing performance when the electric wire section of the terminal-equipped electric wire is bent.

Similarly, the passage hole of the rear holder in the second connector housing as described above has a larger opening area than the radial cross section area of the electric wire section so that the resistance force is reduced which is present when passing the electric wire section through this passage hole, whereby the operability for assembling the wire harness can be improved. Further, in the second connector housing, the portion of the inner circumferential surface of the passage hole in the rear holder is disposed in a position adapted to the inner circumference position of the sealing through hole. If the electric wire section is bent toward this portion, the portion comes into contact with the electric wire section so that a further movement of the electric wire section in the bending direction is suppressed. With this suppression of movement of the electric wire section in the rear holder, it is also possible to suppress the electric wire section tilting in the sealing through hole of the seal element which may cause an inhomogeneous contact with the electric wire section. Accordingly, reduction in the sealing performance of the seal element can be suppressed by operation in a design phase in which the portion corresponding to the bending direction of the electric wire section of the terminal-equipped electric wire is arranged on the inner circumferential surface of the passage hole of the rear holder in a position adapted to the inner circumference position of the sealing through hole. In this manner, the second connector housing enables the operability for assembling the wire harness to be improved while simultaneously suppressing the reduction of the sealing performance when the electric wire section of the terminal-equipped electric wire is bent.

Moreover, the wire harness as described above includes the first connector housing or second connector housing as described above, which enables the operability for assembling the wire harness to be improved while simultaneously suppressing the reduction of the sealing performance when the electric wire section of the terminal-equipped electric wire is bent.

### BRIEF DESCRIPTION OF THE DRAWINGS

FIG. 1 is a perspective view of a wire harness according to a first embodiment;

FIG. 2 is a perspective view of a connector housing of the wire harness according to FIG. 1 with a terminal-equipped electric wire removed;

FIG. 3 shows a partial sectional view of the wire harness according to FIG. 1 along the line V11-V11 in FIG. 1;

FIG. 4 shows a reference example for comparison with the connector housing and wire harness as shown in FIGS. 1 to 3 in a similar sectional view to FIG. 3;

FIG. 5 is a perspective view of a wire harness according to a second embodiment;

FIG. 6 is a perspective view of a connector housing of the wire harness according to FIG. 5 with a terminal-equipped electric wire removed;

FIG. 7 shows a partial sectional view of the wire harness according to FIG. 5 along the line V21-V21 in FIG. 5;

FIG. 8 is a schematic view of two attachment poses in which a rear holder according to FIGS. 5 and 6 may be attached to a housing main body;

FIG. 9 is a plan view of a rear holder according to a third embodiment;

FIG. 10 is a plan view of a rear holder according to a fourth embodiment; and

FIG. 11 is a plan view of a rear holder according to a fifth embodiment.

### DETAILED DESCRIPTION OF THE PREFERRED EMBODIMENTS

Hereinafter, embodiments for a connector housing and a wire harness will be described. First, a first embodiment will be described.

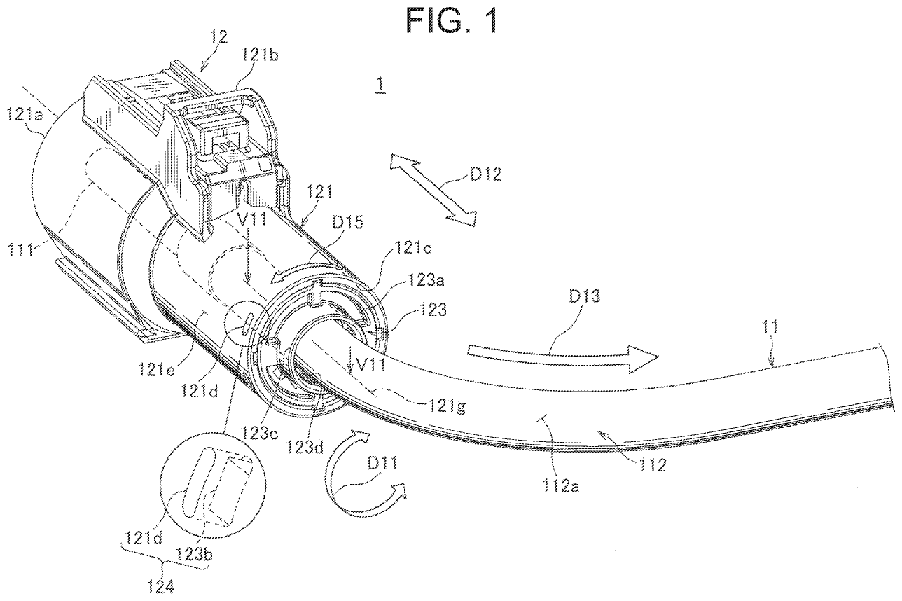

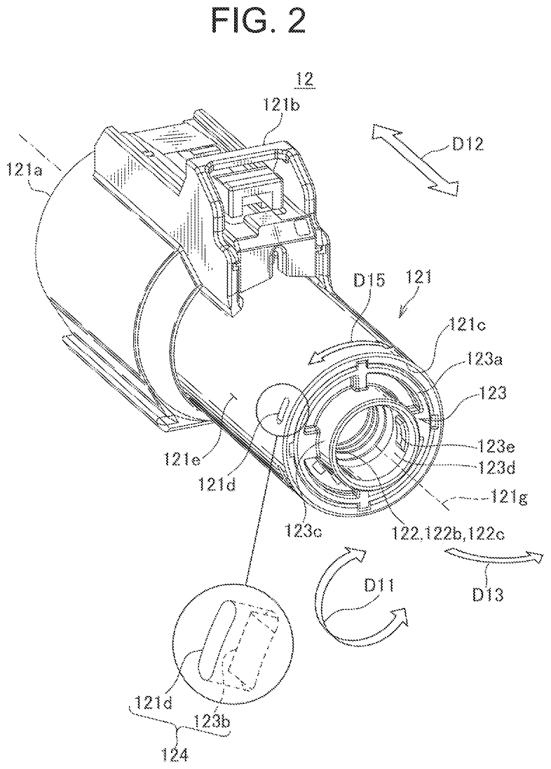

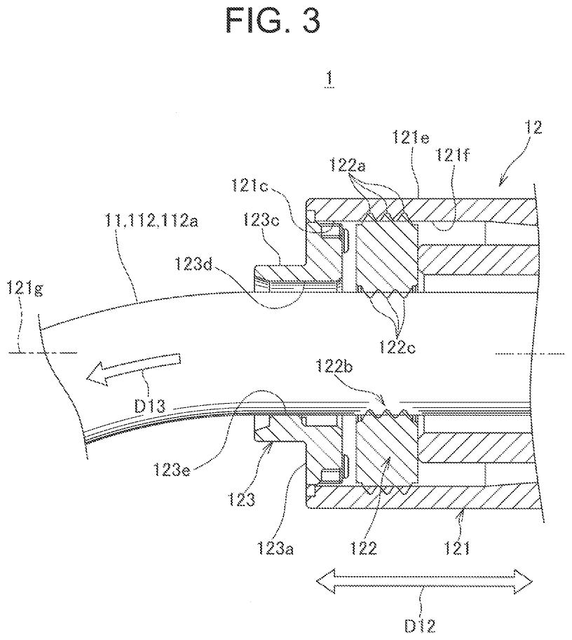

FIG. 1 shows a perspective view of a wire harness according to a first embodiment. FIG. 2 shows perspective view of a connector housing of the wire harness according to FIG. 1 with a terminal-equipped electric wire removed. FIG. 3 shows a partial sectional view of the wire harness according to FIG. 1 along the line V11-V11 in FIG. 1.

A wire harness 1 as shown in these FIGS. 1 to 3 is provided for arrangement at a location which may be subject to liquid splashing such as water, e.g. wiring under a bottom of an automobile. The wire harness 1 according to the present embodiment is configured as a single-pole wire harness, and includes one terminal-equipped electric wire 11 and a connector housing 12.

The terminal-equipped electric wires 11 includes a male connector terminal 111 connected to an end of an electric wire section 112, the connector terminal 111 having a pin shape, wherein the electric wire section 112 is formed by a coated electric wire.

The connector housing 12 is an element for accommodating the one connector terminal 111 of the one terminal-equipped electric wire 11, wherein the connector housing 12 includes a housing main body 121, a seal element 122 and a rear holder 123.

The housing main body 121 is formed from a hard resin in a cylindrical tube shape, and capable of accommodating the connector terminal 111 so as to connect it to a partner connector terminal in a connected side opening 121a for a partner connector. The housing main body 121 includes a locking section 121b on its outer circumferential surface closer to the connected side opening 121a, wherein the locking section 121b is configured to be engaged with a locked section of the partner connector when being fitted to the partner connector. The housing main body 121 further includes engaged sections 121d closer to a rear side opening 121c which is opposite to the connected side opening 121a, wherein the engaged sections 121d are configured to be engaged with engaging sections 123b of the rear holder 123 which will be described below. The engaged sections 121d are elongate holes extending in a circumferential direction D11 of the housing main body 121, wherein the elongate holes extend through a circumferential wall 121e of the housing main body 121, wherein a plurality of engaged section 121d is provided in the circumferential wall 121e closer to the rear side opening 121c and arranged in the circumferential direction D11.

The seal element 122 is a sealing compound which is configured to tightly seal a gap between an outer circumferential surface 112a of the electric wire section 112 of the terminal-equipped electric wire 11 and an inner circumferential surface 121f of the circumferential wall 121e of the housing main body 121, the electric wire section 112 extending to the outside from the rear side opening 121c of the housing main body 121. The seal element 122 is an element having a cylindrical tube shape which is formed with a soft resin, such as a rubber. On an outer circumferential side of the cylindrical tubular seal element 122, a plurality of outer circumferential lips 122a is provided in an axial direction D12 so as to be in tight contact with the inner circumferential 121f of the housing main body 121, the outer circumferential lips 122a extending along the circumferential direction D11. Further, the cylindrical tubular seal element 122 has a sealing through hole 122b therein which comes into tight contact with the outer circumferential surface 112a of the electric wire section 112 on inner circumferential side while inserting the electric wire section 112 through the sealing through hole 122b. On inner circumferential side of the sealing through hole 122b, a plurality of inner circumferential lips 122c is provided in an axial direction D12 so as to be in tight contact with the outer circumferential surface 112a of the electric wire section 112, the inner circumferential lips 122c extending along a circumferential direction D11.

The rear holder 123 is formed in a cylindrical tube shape with a flange containing the same hard resin as the housing main body 121, and is a lid element configured to be attached to the housing main body 121 so as to fit a flange portion 123a of the lid element into the rear side opening 121c and close the rear side opening 121c. On an outer circumference of the flange portion 123a, engaging sections 123b are provided in a claw shape which are engaged with the engaged sections 121d of the housing main body 121, the engaging sections 123b being configured to enter the through-hole-shaped engaged sections 121d in order to be engaged therewith. A plurality of engaging sections 123b is arranged in the circumferential direction D11 on the outer circumference of the flange portion 123a so as to be associated with the plurality of engaged sections 121d in a one-to-one manner.

Further, the rear holder 123 has a tubular section 123c at a center of the flange portion 123a which forms a portion for inserting the electric wire section 112 therethrough, wherein a passage hole 123d is formed in the tubular section 123c for allowing the electric wire section 112 to pass therethrough. These passage hole 123d has a larger opening area than a radial cross section area of the electric wire section 112. On an inner circumferential surface of the passage hole 123d, one protrusion 123e is provided which protrudes from a portion of the inner circumferential surface in the circumferential direction D11 with a protrusion length adapted to an inner circumference position of the sealing through hole 122b of the seal element 122. This protrusion 123e is configured as a rib which extends along the circumferential direction D11, wherein the protrusion 123e has an end edge recessed in an arc shape so as to follow the outer circumferential surface 112a of the electric wire section 112. Further, the protrusion 123e is provided locally on an extending-out side of the electric wire section 112 in the axial direction D12 of the passage hole 123d.

According to the wire harness 1 and the connector housing 12 of the first embodiment as described above, the passage hole 123d of the rear holder 123 has a larger opening area than the radial cross section area of the electric wire section 112. Due to such a configuration of the passage hole 123d, a resistance force is reduced which is present when inserting the electric wire section 112 through the passage hole 123d. With this reduction of the resistance force, it is possible to improve the operability for assembling the wire harness 1 having this connector housing 12.

According to the present embodiment, the wire harness 1 is arranged in such a way that the electric wire section 112 extending out of the passage hole 123d in the rear holder 123 is bent in a bending direction D13, depending on an arrangement geometry of the wire harness 1, as shown in FIG. 1, wherein the bending direction D13 is oriented to the right side in this Figure. In order to address problems which are caused due to such bending of the electric wire section 112 and will be explained below by showing a reference example, the present embodiment provides the protrusion 123e arranged in the portion of the inner circumferential surface of the passage hole 123d in the rear holder 123.

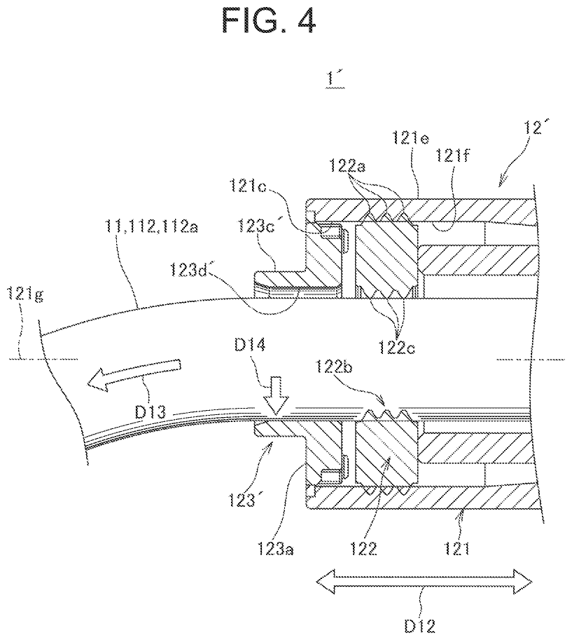

FIG. 4 shows a reference example for comparison with the connector housing and wire harness as shown in FIGS. 1 to 3 in a similar sectional view to FIG. 3. It is to be noted that similar elements in FIG. 4 to those in FIG. 3 are designated by the same reference signs as those in FIG. 3, wherein repeating the description of such similar elements will be omitted below.

In a wire harness 1′ according to the reference example as shown in FIG. 4, a connector housing 12′ does not have a projection such as one shown in FIG. 3 on an inner circumferential surface of a passage hole 123d′ within a tubular section 123c′ of a rear holder 123′. In this case, due to a clearance between the inner circumferential surface of the passage hole 123d′ and an outer circumferential surface 112a of the electric wire section 112 for improved operability, the electric wire section 112 is tilted in a tilting direction D14 depending on the bending direction D13, wherein the tilting direction D14 is oriented toward the inside of the bending. Then, the electric wire section 112 may be tilted in the tilting direction D14 by being drawn to one side also in the sealing through hole 122b of the seal element 122 due to tilting the electric wire section 112 within the passage hole 123d′. This results in compression of the inner circumferential lip 122c on a side which the electric wire section 112 is tilted toward, which increases the tight contact, while on the opposite side, the electric wire section 112 is moved away from the inner circumferential lip 122c and a tight contact on the opposite side may be thus reduced. Such an inhomogeneous tight contact for the sealing through hole 122b may result in reduction of a sealing performance of the seal element 122 which is not desirable.

In contrary to the reference example, the connector housing 12 and thus the wire harness 1 according to the present embodiment includes the protrusion 123e in the portion of the inner circumferential surface of the passage hole 123d in the rear holder 123, the protrusion 123e protruding therefrom with the protrusion length which is adapted to the inner circumference position of the sealing through hole. Further, according to the present embodiment, the portion with the protrusion 123e provided therein is configured at a portion on the inner circumferential surface of the passage hole 123d in the rear holder 123 in a design phase, the portion corresponding to the bending direction D13 of the electric wire section 112 of the terminal-equipped electric wire 11. In this manner, when the electric wire section 112 is bent in the bending direction D13, the protrusion 123e can suppress the electric wire section 112 being tilted in the passage hole 123d of the rear holder 123. With this suppression of tilting in the rear holder 123, it is also possible to suppress the electric wire section 112 tilting in the sealing through hole 122b of the seal element 122 which may cause an inhomogeneous contact with the electric wire section 112. In this manner, the connector housing 12 enables the operability for assembling the wire harness 1 to be improved while simultaneously suppressing the reduction of the sealing performance when the electric wire section 112 of the terminal-equipped electric wire 11 is bent.

Further, according to the present embodiment, the protrusion 123e is arranged on the extending-out side of the electric wire section 112 with respect to the axial direction D12 of the passage hole 123d. According to this configuration, the protrusions 123e for suppression of tilting are provided in the passage hole 123d of the rear holder 123 on the extending-out side of the electric wire section 112 where the electric wire section 112 can be tilted most easily when being bent. Due to the protrusions 123e being arranged in such a position, it is possible to more effectively suppress reduction in the sealing performance when the electric wire section 112 of the terminal-equipped electric wire 11 is bent.

According to the present embodiment, the rear holder 123 is attachable to the housing main body 121 in two attachment poses which are rotationally symmetric at an angle of 180° in a rotating direction D15 around a center axis 121g of the housing main body 121. Change of these attachment poses is accomplished with engagement structures of the rear holder 123 for the housing main body 121 as follows.

First, according to the present embodiment, both of the rear holder 123 and a portion of the housing main body 121 facing the rear side opening 121c has a circular shape which is rotationally symmetric around the center axis 121g of the housing main body 121 in a plan view in a direction of the center axis 121g. Further, the engagement structures 124 include the through-hole-shaped engaged sections 121d at the housing main body 121, and the protrusion-shaped engaging sections 123b at the rear holder 123, wherein the engagement structures 124 are arranged at four locations which are bilaterally symmetric with respect to the center axis 121g in FIGS. 2 and 3. The four engagement structures 124 which are thus arranged are rotationally symmetric around the center axis 121g of the housing main body 121.

This configuration is provided so that the protrusion 123e can be positioned in a position adapted to the bending direction, wherein positioning the protrusion 123e can be accomplished by changing the attachment pose of the rear holder 123 and thus adapting it to two bending directions of the wire harness 1, wherein the two bending directions are bilaterally symmetric with respect to the center axis 121g in FIGS. 2 and 3. This means that the configuration as described above can achieve a suppressed reduction in the sealing performance with respect to the two bending directions.

Furthermore, the change of the attachment poses of the rear holder 123 according to the present embodiment is accomplished, more specifically, with the symmetric shape of the housing main body 121 and the rear holder 123 around the center axis 121g and by symmetrically arranging the engagement structures 124, as described above. With this configuration, the rear holder 123 can be engaged and fixed by changing the attachment pose of the rear holder 123 to the portion of the housing main body 121 facing the rear side opening 121c around the center axis 121g and by thus adapting the attachment pose to the bending direction of the wire harness 1. This means that it is possible to position the protrusion 123e in a desired position adapted to the bending direction. Namely, the above-described configuration enables the reduction in the sealing performance to be suppressed with respect to the two bending directions.

The description of the first embodiment shall be ended here, and hereinafter, a second embodiment will be described.

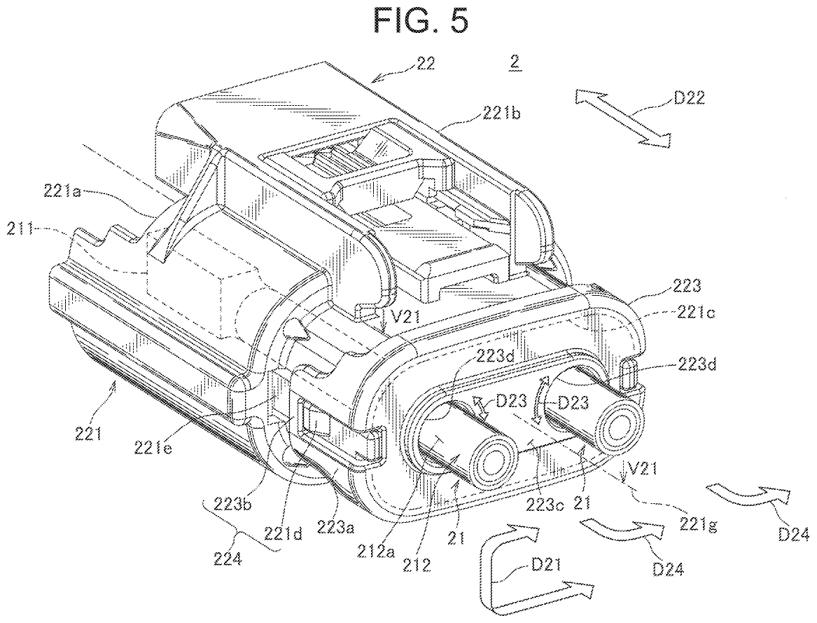

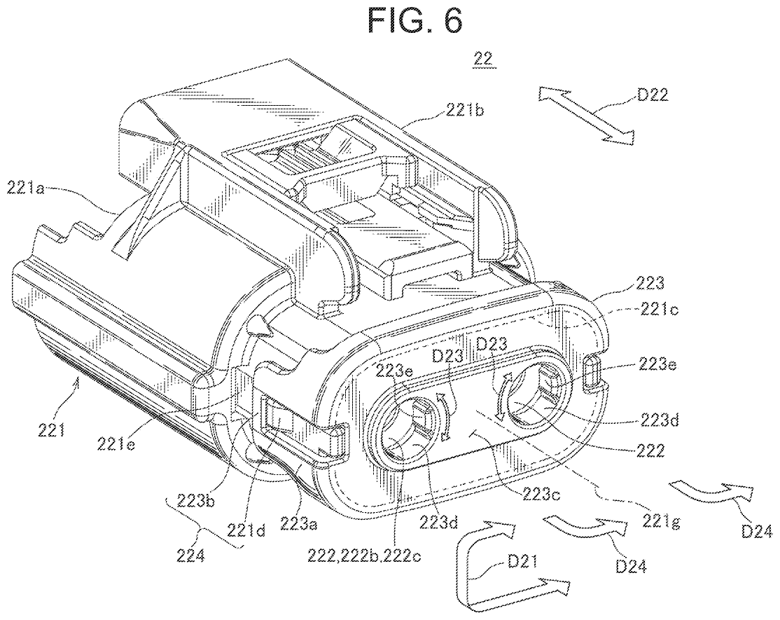

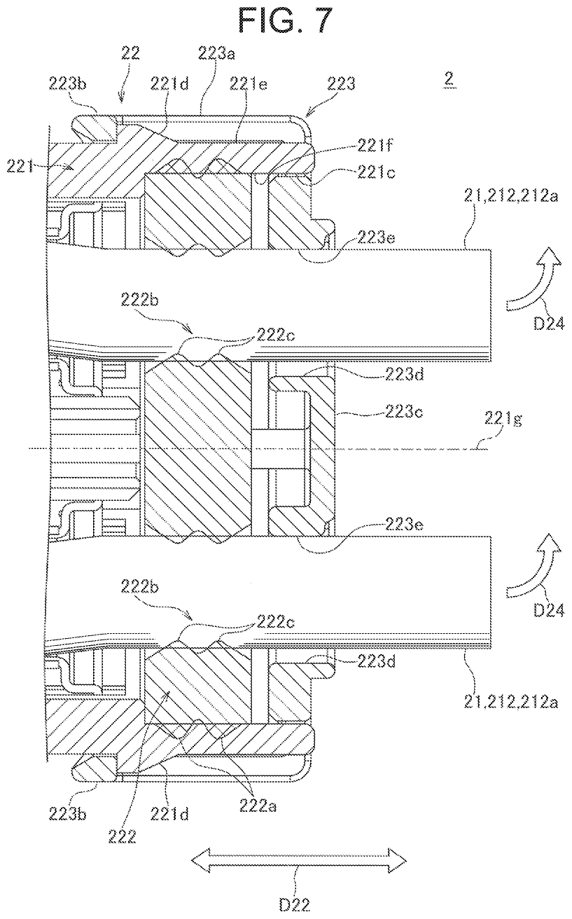

FIG. 5 shows a perspective view of a wire harness according to a second embodiment. FIG. 6 shows a perspective view of a connector housing of the wire harness according to FIG. 5 with a terminal-equipped electric wire removed. Further, FIG. 7 shows a partial sectional view of the wire harness according to FIG. 5 along the line V21-V21 in FIG. 5.

Similarly to the wire harness 1 according to the first embodiment, a wire harness 2 as shown in these FIGS. 5 to 7 is provided for arrangement at a location which may be subject to liquid splashing such as water, e.g. wiring under a bottom of an automobile. However, the wire harness 2 according to the present embodiment is configured as a two-pole wire harness, and includes two terminal-equipped electric wires 21 and a connector housing 22.

Each of the terminal-equipped electric wires 21 includes a female connector terminal 211 connected to an end of an electric wire section 212, the connector terminal 211 having a receptacle shape, wherein the electric wire section 212 is formed by a coated electric wire.

The connector housing 22 is an element for accommodating the two connector terminals 211 of the two terminal-equipped electric wires 21, wherein the connector housing 22 includes a housing main body 221, a seal element 222 and a rear holder 223.

The housing main body 221 is formed from a hard resin in a flat rectangular tube shape, and capable of accommodating the two connector terminals 211 so as to connect them to partner connector terminals in a connected side opening 221a for a partner connector. The housing main body 221 includes a locking section 221b on its outer circumferential surface closer to the connected side opening 221a, wherein the locking section 221b is configured to be engaged with a locked section of the partner connector when being fitted to the partner connector. The housing main body 221 further includes engaged sections 221d closer to a rear side opening 221c which is opposite to the connected side opening 221a, wherein the engaged sections 221d are configured to be engaged with engaging sections 223b of the rear holder 223 which will be described below. The engaged sections 221d are claw-shaped sections which protrude from a circumferential wall 221e of the housing main body 221, wherein one engaged section 221d is provided on each of a pair of opposed lateral faces of the circumferential wall 221e closer to the rear side opening 221c, totally two engaged sections 221d are provided, wherein the opposed lateral faces correspond to short sides of a substantially rectangular plan view shape of the rear side opening 221c.

The seal element 222 is a sealing compound which is configured to tightly seal a gap between outer circumferential surfaces 212a of the electric wire sections 212 of the two terminal-equipped electric wires 21 and an inner circumferential surface 221f the circumferential wall 221e of the housing main body 221, the electric wire sections 212 extending to the outside from the rear side opening 221c of the housing main body 221. The seal element 222 is an element having a substantially rectangular plate shape which is formed with a soft resin, such as a rubber. On an outer circumferential side of the seal element 222, a plurality of outer circumferential lips 222a is provided in an axial direction D22 so as to be in tight contact with the inner circumferential surface 221f of the housing main body 221, the outer circumferential lips 222a extending along a circumferential direction D21 of the seal element 222. Further, the seal element 222 has two sealing through holes 222b arranged therein which come into tight contact with the outer circumferential surfaces 212a of the electric wire sections 212 on inner circumferential sides while each inserting the electric wire section 212 through the sealing through hole 222b. On inner circumferential sides of the sealing through holes 222b, a plurality of inner circumferential lips 222c is provided in an axial direction D22 so as to be in tight contact with the outer circumferential surfaces 212a of the electric wire sections 212, the inner circumferential lips 222c extending along a circumferential direction D23 of the sealing through holes 222b.

The rear holder 223 is configured as a rectangular tubular cap with a lid containing the same hard resin as the housing main body 221, and is a lid element configured to be placed over the rear side opening 221c so as to close it and be attached to the housing main body 221. At a pair of opposed lateral walls of a circumferential wall 223a of the rear holder 223, engaging sections 223b are provided which are engaged with the engaged sections 221d of the housing main body 221, the engaging sections 223b being configured to cross over the claw-shaped engaged sections 221d in order to be engaged therewith, wherein the pair of opposed lateral walls of the rear holder 223 corresponds to short sides of a plan view rectangular shape of the circumferential wall 223a. One of the engaging sections 223b is provided at each of the pair of opposed lateral walls so as to be associated with the pair of engaged sections 221d in a one-to-one manner, totally two engaging sections 223b are provided.

Further, two passage holes 223d are provided in the rear holder 223 in a lid wall 223c forming a rectangular tube shape with a lid, each of the passage holes 223d allowing one of two electric wire sections 212 to pass therethrough, wherein the passage holes 223d extend coaxially with the two sealing through holes 222b of the seal element 222 inside the lid wall 223c. These passage holes 223d have a larger opening area than a radial cross section area of the electric wire sections 212. Further, on an inner circumferential surface of each of the passage holes 223d, one protrusion 223e is provided which protrudes from a portion of the passage hole 223d in its circumferential direction (hereinafter referred to simply as “circumferential direction D23”) which extends along a circumferential direction D23 of the sealing through hole 222b. For each of the passage holes 223d, the protrusion 223e protrudes with a protrusion length, the protrusion length being adapted to an inner circumference position of a corresponding sealing through hole 222b in the seal element 222. This protrusion 223e is configured as a rib which extends along the circumferential direction D23, wherein the protrusion 223e has an end edge recessed in an arc shape so as to follow the outer circumferential surface 212a of the electric wire section 212. Further, the protrusion 223e is configured in a rib shape which extends from an extending-out side of the electric wire section 212 to a side facing the seal element 222 in the axial direction D22 of the passage hole 223d.

According to the wire harness 2 and the connector housing 22 of the second embodiment as described above, the passage holes 223d of the rear holder 223 have a larger opening area than the radial cross section area of the electric wire sections 212. Due to such a configuration of the passage holes 223d, a resistance force is reduced which is present when inserting the electric wire sections 212 through the passage holes 223d. With this reduction of the resistance force, it is possible to improve the operability for assembling the wire harness 2 having this connector housing 22.

Similarly, the electric wire section 212 extending out of the passage hole 223d in the rear holder 223 according to the present embodiment is bent in a bending direction D24 as shown by arrows in FIGS. 5 and 6, depending on an arrangement geometry of the wire harness 2. For suppressing the electric wire section 212 being tilted within the passage hole 223d of the rear holder 223 due to the bending, the protrusion 223e is arranged at the portion of the inner circumferential surface of the passage hole 223d.

According to the present embodiment, the portion with the protrusion 223e provided therein is configured at a portion on the inner circumferential surface of the passage hole 223d in the rear holder 223 in a design phase, the portion corresponding to the bending direction D24 of the electric wire section 212 of the terminal-equipped electric wire 21. In this manner, when the electric wire section 212 is bent in the bending direction D24, the protrusion 223e can suppress the electric wire section 212 being tilted in the passage hole 223d of the rear holder 223. With this suppression of tilting in the rear holder 223, it is also possible to suppress the electric wire section 212 tilting in the sealing through hole 222b of the seal element 222 which may cause an inhomogeneous contact with the electric wire section 212. In this manner, the connector housing 22 enables the operability for assembling the wire harness 2 to be improved while simultaneously suppressing the reduction of the sealing performance when the electric wire section 212 of the terminal-equipped electric wire 21 is bent.

Further, according to the present embodiment, the protrusion 223e at the rear holder 223 has a rib shape which extends from an extending-out side of the electric wire section 212 to a side facing the seal element 222 in the axial direction D22 of the passage hole 223d. According to this configuration, the protrusion 223e is provided in the passage hole 223d of the rear holder 223, the protrusion 223e having a rib shape which extends from the extending-out side of the electric wire section 212 on which the electric wire section 212 can be tilted most easily when being bent, wherein the rib shape extends to the side facing the seal element 222 where the sealing performance tends to be affected. Due to the protrusion 223e being configured in such a rib shape, it is possible to further suppress reduction in the sealing performance when the electric wire sections 212 of the terminal-equipped electric wires 21 are bent.

Similarly to the first embodiment as described above, the rear holder 223 according to the present embodiment is attachable to the housing main body 221 in two attachment poses which are rotationally symmetric around a center axis 221g of the housing main body 221.

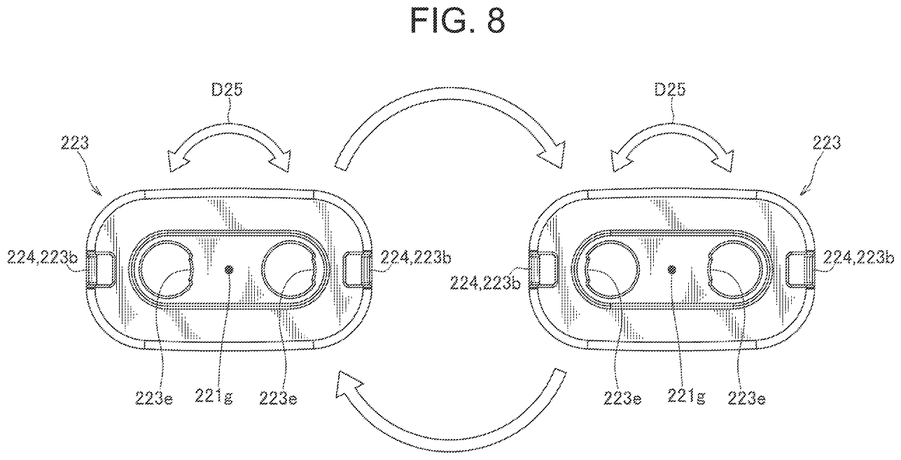

FIG. 8 shows a schematic view of two attachment poses in which the rear holder according to FIGS. 5 and 6 may be attached to the housing main body.

As shown in this FIG. 8, the rear holder 223 is attachable to the housing main body 221 in two attachment poses which are rotationally symmetric at an angle of 180° in a rotating direction D25 around a center axis 221g of the housing main body 221. Change of these attachment poses is accomplished with engagement structures of the rear holder 223 for the housing main body 221 as follows.

First, both of the rear holder 223 and a portion of the housing main body 221 facing the rear side opening 221c according to the present embodiment has a flat rectangular shape in a plan view in a direction of the center axis 221g of the housing main body 221, as shown in FIGS. 5 and 6. This flat rectangular shape is rotationally symmetric around the center axis 221g. Further, the engagement structures 224 include the engaged sections 221d at the housing main body 221, and the engaging sections 223b at the rear holder 223, wherein the engagement structures 224 are arranged at two locations which are bilaterally symmetric with respect to the center axis 221g in FIGS. 5 to 8. The two engagement structures 224 which are thus arranged are rotationally symmetric around the center axis 221g of the housing main body 221.

This configuration is provided so that the protrusion 223e can be positioned in a position adapted to the bending direction, wherein positioning the protrusion 223e can be accomplished by changing the attachment pose of the rear holder 223 and thus adapting it to two bending directions of the wire harness 2, wherein the two bending directions are bilaterally symmetric with respect to the center axis 221g in FIGS. 5 to 7. This means that the configuration as described above can achieve a suppressed reduction in the sealing performance with respect to the two bending directions.

Similarly, the change of the attachment poses of the rear holder 223 according to the present embodiment is further accomplished, more specifically, with the symmetric shape of the housing main body 221 and the rear holder 223 around the center axis 221g and by symmetrically arranging the engagement structures 224, as described above. With this configuration, the rear holder 223 can be engaged and fixed by changing the attachment pose of the rear holder 223 to the portion of the housing main body 221 facing the rear side opening 221c around the center axis 221g and by thus adapting the attachment pose to the bending direction of the wire harness 2. This means that it is possible to position the protrusion 223e in a desired position adapted to the bending direction. Namely, the above-described configuration enables the reduction in the sealing performance to be suppressed with respect to the two bending directions.

The description of the second embodiment shall be ended here, and hereinafter, third and fourth embodiments will be described. Both of these third and fourth embodiments are exemplar variations of the rear holder according to the above-described second embodiment. On the other hand, the remaining features of a connector housing and/or wire harness according to the third and fourth embodiments are identical with those of the connector housing 22 and/or wire harness 2 according to the second embodiment. The following description of the third and fourth embodiments is focused on differences from the second embodiment, wherein description and/or illustration will be omitted for identical features of these embodiments.

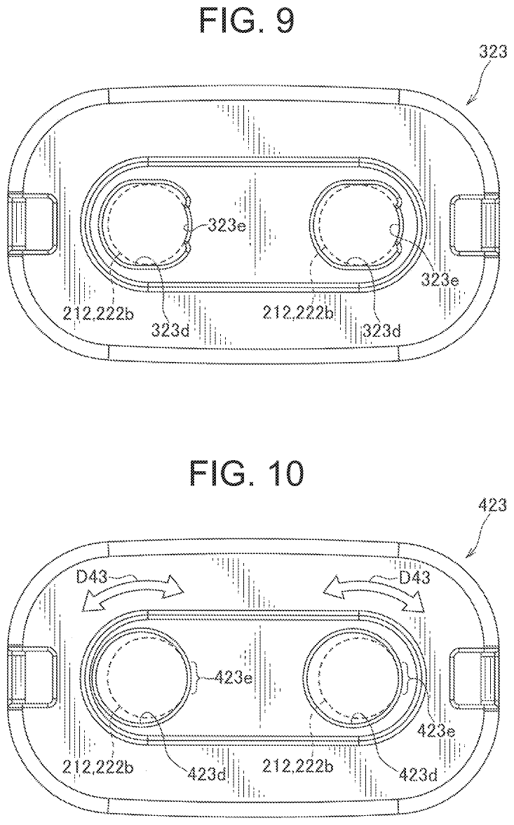

FIG. 9 shows a plan view of a rear holder according to a third embodiment. FIG. 10 shows a plan view of a rear holder according to a fourth embodiment. It is to be noted that similar elements in FIGS. 9 and 10 to those of the second embodiment as shown in FIGS. 5 to 8 are designated by the same reference signs as those in FIGS. 5 to 8, wherein repeating the description of such similar elements will be omitted below.

According to the third embodiment as shown in FIG. 9, a rear holder 323 has two passage holes 323d for electric wire sections 212, wherein the two passage holes 323d are not circular holes, but elongate holes which are shown as being oriented horizontally in this Figure. The passage holes 323d having an elongate hole shape has a short axis dimension in a plan view which coincides with a diameter of the electric wire section 212 or is slightly larger. On the other hand, the passage holes 323d have a long axis dimension which is significantly larger than the diameter of the electric wire section 212. Due to the elongate hole shape with such dimensions, the passage holes 323d are configured as through holes which have a larger opening area than a radial cross section area of the electric wire sections. These passage holes 323d having such an elongate hole shape are further arranged coaxially with the sealing through holes 222b. Furthermore, a protrusion 323e is provided on an arc section of an inner circumferential surface of each of the passage holes 323d which is located on the right side in the Figure.

Of course, similarly to the above-mentioned first and second embodiments, the third embodiment as described above enables the operability for assembling the wire harness to be improved while simultaneously suppressing the reduction of the sealing performance when the electric wire section 212 is bent.

According to the fourth embodiment as shown in FIG. 10, a rear holder 423 has two passage holes 423d for electric wire sections 212 which are configured as circular holes, wherein the circular holes, however, do not have any protrusion on their inner circumferential surfaces. The passage holes 423d according to the present embodiment have a larger opening area than a radial cross section area of the electric wire sections 212. Further, each of the passage holes 423d is configured so that a portion 423e of its inner circumferential surface in a circumferential direction D43 (a portion on the right side in the Figure) is positioned in a position corresponding to an inner circumference position of the sealing through hole 222b. For such positioning, each of the passage holes 423d according to the present embodiment is arranged with its center being slightly offset to the left in the Figure with regard to the sealing through hole 222b in a plan view. According to the present embodiment, the portion 423e of the passage hole 423d which is offset in this manner—the portion 423e corresponds to the inner circumference position of the sealing through hole 222b and positioned on the right side in the Figure—fulfills the same role as the protrusions 123e, 223e, 323e according to the other first to third embodiments.

Also according to the fourth embodiment as described above, the passage holes 423d of the rear holder 423 have a larger opening area than the radial cross section area of the electric wire section 212. This reduces the resistance force which is present when passing the electric wire sections 212 through the passage holes 423d, whereby the operability for assembling can be improved. Further, according to the present embodiment, the portion 423e of the inner circumferential surface of the passage hole 423d is disposed in the position adapted to the inner circumference position of the sealing through hole 222b. If the electric wire section 212 is bent toward this portion 423e, the portion 423e comes into contact with the electric wire section 212 so that a further movement of the electric wire section 212 is suppressed. With this suppression of movement of the electric wire section 212 in the rear holder 423, it is also possible to suppress tilting in the sealing through hole 222b which may cause an inhomogeneous contact with the electric wire section 212. As a result, the reduction in the sealing performance can be suppressed. In this manner, the fourth embodiment enables the operability for assembling the wire harness to be improved while simultaneously suppressing the reduction of the sealing performance when the electric wire section 212 of the terminal-equipped electric wire is bent, similarly to the first and second embodiments as described above.

The description of the third and fourth embodiments shall be ended here, and hereinafter, a fifth embodiment will be described. This fifth embodiment is an exemplar variation of the rear holder according to the above-described first embodiment. On the other hand, the remaining features of a connector housing and/or wire harness according to the fifth embodiment are identical with those of the connector housing 12 and/or wire harness 1 according to the first embodiment. The following description of the fifth embodiment is focused on differences from the first embodiment, wherein description and/or illustration will be omitted for identical features of these embodiments.

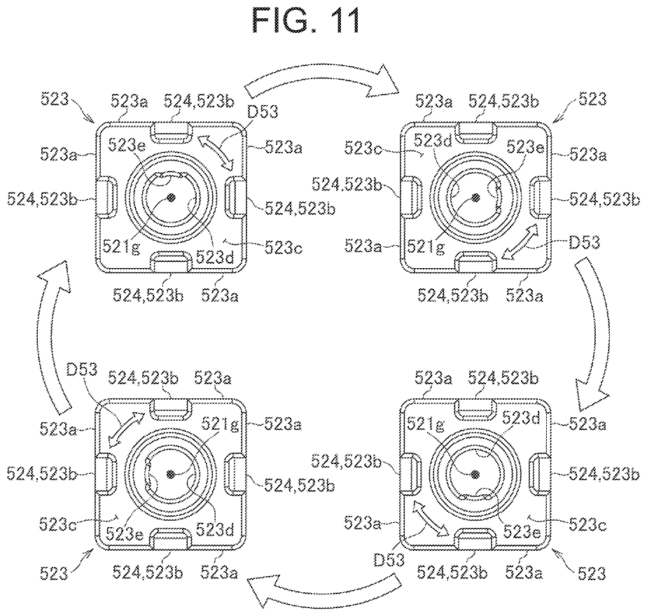

FIG. 11 shows a plan view of a rear holder according to a fifth embodiment.

A rear holder 523 according to the present embodiment is provided at a connector housing for a single-pole wire harness, similarly to the above-described first embodiment. However, while the rear holder 123 according to the first embodiment is configured to be fitted into the housing main body 121 having a cylindrical tube shape, the rear holder 523 according to the present embodiment is configured as a cap having a square-tube shape with lid which is placed over a housing main body with a square tube shape. Further, one engaging section 523b is provided at each of four lateral walls 523a which form the square-tube shape with lid together, totally four engaging sections 523b, wherein the engaging sections 523b are comparable to the engaging sections 223b of the rear holder 223 according to the second embodiment. Similarly, one engaged section is provided at each of four lateral walls of the housing main body with a square tube shape, totally four engaged sections in order to be associated to the four engaging sections 523b in a one-to-one manner, wherein the engaged sections are comparable to the engaged sections 221d of the housing main body 221 according to the second embodiment. According to the present embodiment, four engagement structures 524 have the engaging sections 523b of the rear holder 523 and the engaged sections of the housing main body, wherein the engagement structures 524 are arranged at an angle of 90° therebetween so as to be rotationally symmetric around a center axis 521g of the housing main body.

Furthermore, in the rear holder 523, a passage hole 523d for an electric wire section is formed at a center in a square lid wall 523c, wherein the passage hole 523d is configured as a circular hole having a larger opening area than a radial cross section area of the electric wire section. Furthermore, one protrusion 523e is provided which protrudes from a portion of the passage hole 523d in a circumferential direction D53.

The rear holder 523 is attachable to the housing main body in four attachment poses by rotating the rear holder 523 by 900 around the center axis 521g in the circumferential direction D53. In the four attachment poses, the protrusion 523 is oriented in different directions which are offset by 90° in the circumferential direction D53, as shown in FIG. 11.

Of course, similarly to the above-mentioned first embodiment, the fifth embodiment as described above enables the operability for assembling the wire harness to be improved while simultaneously suppressing the reduction of the sealing performance when the electric wire section is bent.

Further, the fifth embodiment is provided so that the rear holder 523 is attachable to the housing main body in the four attachment poses which are rotationally symmetric around the center axis 521g of the housing main body, which allows the rear holder 523 to be adapted to four different bending directions of the wire harness. This is preferable because the wire harness can be arranged in more degrees of freedom correspondingly.

It is to be noted that the first to fifth embodiments as described above merely show representative embodiments for the connector housing and wire harness, wherein the connector housing and wire harness are not limited thereto and may be implemented in various modifications.

For example, the first to fifth embodiments as described above show the wire harness 1, 2 as an example for the wire harness, the wire harness 1, 2 being provided for arrangement at a location which may be subject to liquid splashing such as water, e.g. wiring under a bottom of an automobile. However, the wire harness is not limited thereto, but may be configured to be arranged within a vehicle cabin of an automobile, wherein the wire harness may be arranged in any specific manner.

Furthermore, the first to fifth embodiments as described above show the single-pole and two-pole connector housings and wire harnesses as examples for the connector housing and wire harness. However, the number of poles for the connector housing and wire harness is not limited to one or two, but they may have three or more poles. Further, in the case of a multi-pole connector housing and/or wire harness, arrangement of the terminal-equipped electric wire is not limited to a horizontal arrangement as shown in the second to fourth embodiments, but may be arranged vertically, or in multiple rows such as two or three rows.

Furthermore, the first to fifth embodiments as described above show the circular passage holes 123d, 223d, 423d, 523d and the horizontally elongate passage holes 323d as examples for the passage holes in the rear holder. However, the passage hole in the rear holder is not limited thereto, but may have any specific shape, such as a vertically elongate hole and/or polygonal hole, as far as it is a passage hole having a larger opening area than a radial cross section area of the electric wire section of the electric wire which allows the electric wire section to pass through the passage hole.

Moreover, the first to third and fifth embodiments as described above show the rib-shaped protrusions 123e, 223e, 323e, 523e having an end edge which is recessed in an arc shape, as an example for the protrusion in the rear holder. However, the protrusion is not limited thereto, but may have any specific shape, such as a rectangular protrusion having a flat end edge and/or a dome-shaped protrusion having a convex cup shape.

Furthermore, the first and fifth embodiments as described above show the protrusions 123e, 523e which are provided in the passage hole 123d, 523d, being localized to the extending-out side of the electric wire section, as an example for the protrusion of the rear holder. Moreover, the second and third embodiments show the protrusions 223e, 323e which is provided in a rib shape in the passage hole 223d, 323d, the rib shape extending from the extending-out side of the electric wire section to the side facing the seal element. However, the protrusion of the rear holder is not limited thereto, but may be provided e.g. in a middle portion of the passage hole which is far from the extending-out side of the electric wire section and/or the side facing the seal element. However, the protrusions 123e, 523e, 223e, 323e which are localized to the extending-out side of the electric wire section and/or extend from the extending-out side of the electric wire section to the side facing the seal element can more effectively suppress the reduction in the sealing performance, as described above.

Moreover, the first to fifth embodiments as described above show the rear holders 123, 223, 323, 423, 523 which are attachable to the housing main body in two or four attachment poses, these attachment poses being rotationally symmetric around the center axis of the housing main body, as examples for the rear holder. However, the rear holder is not limited thereto, but may be attachable to the housing main body only in one attachment pose. However, the rear holder 123, 223, 323, 423, 523 which is attachable to the housing main body in multiple attachment poses as described above enables the reduction in the sealing performance to be suppressed with respect to multiple bending directions of the electric wire section. Further, the number of the multiple attachment poses of the rear holder is not limited to two or four, but may be three or five or more.

Furthermore, the first embodiment as described above shows the engagement structures 124 which have the hole-shaped engaged sections in the housing main body and the claw-shaped engaging sections at the rear holder, as an example for the engagement structure of the rear holder for the housing main body. Moreover, the second to fifth embodiments show the engagement structures 224, 524 by way of example which have the claw-shaped engaged sections at the housing main body and the engaging sections at the rear holder, wherein the engaging sections are configured to cross over the claws and be engaged therewith. However, the engagement structures are not limited thereto, but may be engaged in any specific manner as long as the engagement structures are configured with engaged sections at the housing main body and engaging sections at the rear holder, wherein the engaging sections are configured to be engaged with the engaged sections.

### REFERENCE SIGNS LIST

1, 2 Wire harness
11, 21 Terminal-equipped electric wire
12, 22 Connector housing
111, 211 Connector terminal
112, 212 Electric wire section
112a, 212a Outer circumferential surface
121, 221 Housing main body
121a, 221a Connected side opening
121b, 221b Locking section
121c, 221c Rear side opening
121d, 221d Engaged sections
121e, 221e, 223a Circumferential walls
121f, 221f Inner circumferential surface
121g, 221g, 521g Center axis
122, 222 Seal element
122a, 222a Outer circumferential lips
122b, 222b Sealing through hole
122c, 222c Inner circumferential lips
123, 223, 323, 423, 523 Rear holder
123a Flange portion
123b, 223b, 523b Engaging sections
123c Tubular section
123d, 223d, 323d, 423d, 523d Passage hole
123e, 223e, 323e, 523e Protrusion
124, 224, 524 Engagement structures
223c, 523c Lid wall
423e Portion
523a Lateral walls
D11, D21, D23, D53 Circumferential direction
D12, D22 Axial direction
D13, D24 Bending direction
D14 Tilting direction
D15, D25 Rotating direction

What is claimed is:

1. A connector housing comprising:
a housing main body having a tubular shape and configured to accommodate a connector terminal of a terminal-equipped electric wire in order to connect the connector terminal to a partner connector terminal in a connected side opening of the housing main body for a partner connector;
a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and
a rear holder which is a lid element configured to be attached to the housing main body so as to close the rear side opening and has a passage hole and a protrusion, the passage hole allowing the electric wire section to pass therethrough and having a larger opening area than a radial cross section area of the electric wire section, wherein the protrusion protrudes from a portion of an inner circumferential surface of the passage hole in a circumferential direction with a protrusion length, the protrusion length being adapted to an inner circumference position of the sealing through hole.

2. The connector housing according to claim 1,
wherein the protrusion of the rear holder is provided at least on an extending-out side of the electric wire section in an axial direction of the passage hole.

3. The connector housing according to claim 1,
wherein the protrusion of the rear holder has a rib shape which extends from an extending-out side of the electric wire section to a side facing the seal element in an axial direction of the passage hole.

4. The connector housing according to claim 2,
wherein the protrusion of the rear holder has a rib shape which extends from an extending-out side of the electric wire section to a side facing the seal element in an axial direction of the passage hole.

5. A connector housing comprising:
a housing main body having a tubular shape and configured to accommodate a connector terminal of a terminal-equipped electric wire in order to connect the connector terminal to a partner connector terminal in a connected side opening of the housing main body for a partner connector;
a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and
a rear holder which is a lid element configured to be attached to the housing main body so as to close the rear side opening and has a passage hole allowing the electric wire section to pass therethrough and having a larger opening area than a radial cross section area of the electric wire section, wherein the passage hole is disposed in such a way that a portion of an inner circumferential surface of the passage hole in a circumferential direction is positioned in a position adapted to an inner circumference position of the sealing through hole.

6. The connector housing according to claim 1,
wherein the rear holder is attachable to the housing main body in multiple attachment poses which are rotationally symmetric around a center axis of the housing main body.

7. The connector housing according to claim 5,
wherein the rear holder is attachable to the housing main body in multiple attachment poses which are rotationally symmetric around a center axis of the housing main body.

8. The connector housing according to claim 1,
wherein both of a portion of the housing main body facing the rear side opening and the rear holder to be attached to the portion have a shape which is rotationally symmetric around a center axis of the housing main body in a plan view in a direction of the center axis,
wherein the connector housing further comprises a plurality of engagement structures which include engaged sections and engaging sections to be engaged with the engaged sections, wherein the engaged sections are provided at the portion of the housing main body facing the rear side opening and the engaging sections are provided at the rear holder, and
wherein the plurality of engagement structures is arranged so as to be rotationally symmetric around the center axis of the housing main body.

9. The connector housing according to claim 5,
wherein both of a portion of the housing main body facing the rear side opening and the rear holder to be attached to the portion have a shape which is rotationally symmetric around a center axis of the housing main body in a plan view in a direction of the center axis,
wherein the connector housing further comprises a plurality of engagement structures which include engaged sections and engaging sections to be engaged with the engaged sections, wherein the engaged sections are provided at the portion of the housing main body facing the rear side opening and the engaging sections are provided at the rear holder, and
wherein the plurality of engagement structures is arranged so as to be rotationally symmetric around the center axis of the housing main body.

10. A wire harness comprising:
a terminal-equipped electric wire; and
the connector housing according to claim 1 which accommodates the connector terminal of the terminal-equipped electric wire.

11. A wire harness comprising:
a terminal-equipped electric wire; and
the connector housing according to claim 5 which accommodates the connector terminal of the terminal-equipped electric wire.
